(19) United States
(12) Patent Application Publication
(10) Pub. No.: US 2011/0307415 A1
(43) Pub. Date: Dec. 15, 2011

(54) System, Method and Computer Program Product for Measuring Risk Levels in a Stock Market by Providing a Volatility, Skewness and Kurtosis Index

(75) Inventors: Lionel Martellini, Biot (FR); Felix Goltz, Nice (FR); Stoyan Stoyanov, Singapore (SG)

(73) Assignee: EDHEC RISK CONSULTING LIMITED, London (GB)

(21) Appl. No.: 13/156,342

(22) Filed: Jun. 9, 2011

Related U.S. Application Data
(60) Provisional application No. 61/352,846, filed on Jun. 9, 2010.

(51) Int. Cl. G06Q 40/00

(52) U.S. Cl. 705/36 R

(57) ABSTRACT

A system, method and computer program product for constructing a volatility index by using at least one processor, the method comprising: obtaining, by at least one computing device having at least one computer processor, a universe of securities; selecting, by the at least one computing device, constituent securities at a given date; computing, by the at least one computing device, constituent returns for said constituent securities; filtering, by the at least one computing device, outliers; applying, by the at least one computing device, weighting comprising computing at least one of a second, third or fourth moment to obtain the index.

### BACKGROUND OF THE INVENTION

1. Field of the Invention

The present invention relates generally to methods, systems, and computer program products in financial risk management that extract information from the prices and returns of financial assets, and more particularly to methods, systems, and computer program products that allow estimating stock market volatility and related risk measures.

2. Related Art

Conventional solutions include: (i) option-implied volatility measures, which extract market volatility from index option prices, and (ii) time-series models, which estimate market volatility from the time series of past index returns.

Option implied-volatility measures use a set of options with different exercise prices to estimate the risk-neutral distribution from option prices. Shortcomings of the use of option implied-volatility measures include:
availability of index options with sufficient liquidity for all strikes, limits the indices for which such an option implied-volatility measure can be computed;
an option implied-volatility measure relies on the assumption of no arbitrage (see Breeden, D. and Litzenberger, R., 1978, Prices of State Contingent Claims Implicit in Options Prices, Journal of Business 51, pp. 621-651) whereas in practice it has been shown that arbitrage opportunities may exist in option markets (i.e., frequent violations of put call parity in practice);
option implied-volatility indices can only provide a measure of systematic market volatility whereas levels of idiosyncratic volatility may be informative to investors as well; and
from a technical standpoint, non-parametric extraction methods for risk neutral distributions may lead to negative values for the density function which is inconsistent with the interpretation as a probability.

Time series models use a series of past return observations on the index to infer the volatility of the underlying price process. Models that are used in practice include exponential moving averages and generalized autoregressive conditional heteroskedasticity (GARCH) models. A shortcoming of such methods is the existence of considerable model risk as the assumed model may not be an appropriate description of the true process governing the time series of returns. A further shortcoming is considerable estimation risk as the true model parameters are unknown and have to be estimated with a limited amount of data.

In 1993, the Chicago Board Options Exchange® (CBOE®) introduced the CBOE Volatility Index®, VIX®, which was originally designed to measure the market's expectation of 30-day volatility implied by at-the-money S&P 100® Index (OEX®) option prices. VIX soon became the premier benchmark for U.S. stock market volatility. It is regularly featured in the Wall Street Journal, Barron's and other leading financial publications, as well as business news shows on CNBC, Bloomberg TV and CNN/Money, where VIX is often referred to as the “fear index.”

Ten years later in 2003, CBOE together with Goldman Sachs, updated the VIX to reflect a new way to measure expected volatility, one that continues to be widely used by financial theorists, risk managers and volatility traders alike. The new VIX is based on the S&P 500® Index (SPXSM), the core index for U.S. equities, and estimates expected volatility by averaging the weighted prices of SPX puts and calls over a wide range of strike prices. By supplying a script for replicating volatility exposure with a portfolio of SPX options, this new methodology transformed VIX from an abstract concept into a practical standard for trading and hedging volatility.

Overall, the conventional methods to extract volatility measures suffer from two main shortcomings:
based on a very limited amount of information on a single asset, complex methods are used that make relatively strong assumptions; and
extending such methods to account for not only volatility but also to measures of the extreme risks inherent in the returns distribution will render the methods even more complex and data problems even more pronounced.

### SUMMARY OF EXAMPLE EMBODIMENTS OF THE INVENTION

An exemplary embodiment of the present invention is directed to a system, method and/or computer program product for constructing data indicative of a volatility index using at least one processor, the method comprising: obtaining, by at least one computing device having at least one computer processor, data indicative of a universe of securities; selecting, by the at least one computing device, data indicative of constituent securities at a given date; computing, by the at least one computing device, data indicative of constituent returns for said constituent securities; filtering, by the at least one computing device, data indicative of outliers; applying, by the at least one computing device, weighting comprising computing at least one of a second, third or fourth moment to obtain the index.

According to an example embodiment of the present invention, in order to compute an example index or indices of volatility, skewness and/or kurtosis, for a reference universe of stocks (such as, e.g., but not limited to, a broad market index, or a sector), information on an entire constituent universe may be obtained, received, or gathered by an exemplary one or more computer data processing systems including at least one electronic computer processor. In an example embodiment, a universe may include, e.g., but not limited to, all publicly traded stocks in a given market, a given country, a given segment, a given subset of a market, a given industry sector, and/or other group of securities, etc. In obtaining or gathering information, in particular, on or more computing devices may obtain, collect, or receive information on, among other things, past returns data for use in, e.g., but not limited to, filtering stocks, (or other securities), as well as on current returns for use in construction of a current volatility index value, according to an exemplary embodiment of the present invention. The process may include, electronically applying one or more filters to all available constituent stocks, with an aim of electronically excluding, e.g., but not limited to, data regarding certain stocks from index computation. For example, it may be desirable to avoid, e.g., but not limited to, undue influence of illiquid stocks, or undue inclusion of irrelevant noise from outlier stocks. Once, a filtered universe of stocks has been constructed by the one or more computing devices, current returns of each stock may be computed by the one or more computing devices, as well as expected return data may be obtained and/or calculated across, e.g., all stocks, for a given current time period. By computing current returns, and expected return data, this allows the one or more electronic computing devices to compute deviations from the expected return for each given individual stock. To obtain or calculate a volatility index, according to an exemplary embodiment of the present invention, deviations from the expected value may be squared by the at least one computing device, and a weighting mechanism may be applied to such squared deviations to result in an aggregate measure of volatility. Such an example volatility index may provide information on average stock-specific volatility in a respective universe of stocks. The process, according to an example embodiment, may also enable the one or more electronic computing devices to compute indices of, e.g., skewness, and/or, kurtosis, by taking the next respective ordered powers of the deviations, in a similar manner. According to an example embodiment, e.g., regular updating of the example constituent universe, and of the return information on individual stocks, and also regular application of the filtering procedure by the computing device may allow the one or more computing devices to maintain and/or compute these indices frequently, periodically or aperiodically. For example, such indices may be maintained by, e.g., but not limited to, providing, e.g., daily (or other periodic) index values at, e.g., market close, according to an example embodiment of the present invention.

In another exemplary embodiment, a machine readable medium that provides instructions which when executed by a computing platform, may cause the computing platform to perform operations, which may include a method of computing a volatility index, a skewness index and/or or a kurtosis index, according to an exemplary embodiment.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of various example embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 depicts an example embodiment of an exemplary process flow diagram for constructing an example embodiment of a volatility index, in accordance with an exemplary embodiment of the present invention including, e.g., exemplary steps of an example volatility, skewness, and kurtosis indices construction process(es);

FIG. 2 depicts a more detailed exemplary process flow diagram of an example embodiment of organization of example data flow and an example overall process in accordance with an exemplary embodiment of the present invention, including for example, an exemplary overall flowchart; and

FIG. 3 depicts an exemplary electronic computer processing and communications embodiment for the present invention, for an exemplary, but nonlimiting computing and/or communications environment.

### DETAILED DESCRIPTION OF VARIOUS EXEMPLARY EMBODIMENTS

Conventional CBOE Volatility Index® (VIX) Step-by-Step Calculation

The Chicago Board Options Exchange introduced the CBOE Volatility Index® in 1993. The CBOE VIX is calculated from real-time option prices and is disseminated throughout the day. US Patent Publication 2005/0102214 A1 (“214 publication”) sets forth another VIX, which derives expected volatility by averaging weighted prices of out-of-the-money put and call options. However, both such conventional VIX have the shortcoming of being based on options.

Stock indexes, such as the S&P 500, are calculated using the prices of their component stocks. Each index employs rules that govern the selection of component securities and a formula to calculate index values.

An exemplary conventional VIX of the '214 Publication is a volatility index comprised of options rather than stocks, with the price of each option reflecting the market's expectation of future volatility. Like conventional indexes, the '214 Publication VIX employs rules for selecting component options and a formula to calculate index values.

The generalized formula used in the VIX calculation of the '214 Publication is:

$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2}$$

where

σ is VIX/100→VIX=σ×100;

T is the time to expiration;

F is the forward index level derived from index option prices;

K0 is the first strike below the forward index level, F;

Ki is the strike price of ith out-of-the-money option; a call if Ki>K0 and a put if Ki<K0; both put and call if Ki=K0; and

ΔKi is the interval between strike prices—half the difference between the strike on either side of Ki:

$$Δ {K}_{i} = \frac{{K}_{i + 1} - {K}_{i - 1}}{2}$$

It may be noted that ΔK for the lowest strike may simply be the difference between the lowest strike and the next higher strike. Likewise, ΔK for the highest strike may be the difference between the highest strike and the next lower strike.

R is the risk-free interest rate to expiration.

Q(Ki) is the midpoint of the bid-ask spread for each option with strike Ki.

An Improved VIX according to Various Exemplary Embodiments of the Present Invention

According to an exemplary embodiment of the present invention, in order to compute an example index or indices of volatility, skewness and kurtosis, for a reference universe of stocks, a skilled person may gather information on an entire constituent universe. Exemplary stocks or universes of stocks may include, for example, but are not limited to, broad market indices or sectors. In an exemplary embodiment, a universe may include, e.g., but is not limited to, all publicly traded stocks in a given market, a given country, a given segment, a given subset of a market, a given industry sector, or other group of securities.

In various exemplary embodiments, volatility refers to a statistical measure of the tendency of a market or security to rise or fall sharply within a period of time, and may be calculated, for example, by using variance or a standard deviation of a price or return, according to an exemplary embodiment. A measure of relative volatility of a stock as compared to the overall market is the stock's beta. A highly volatile market means that prices have large swings in very short periods of time.

In one or more exemplary embodiments, skew may refer to a statistic describing a situation's asymmetry in relation to a normal distribution. A positive skew normally describes a distribution favoring a right tail of the normal distribution, whereas a negative skew describes a distribution favoring a left tail of the normal distribution. Risk-averse investors do not like negative skewness.

In one or more exemplary embodiments, kurtosis may refer to a statistical measure used to describe the distribution of observed data around a mean. As used generally, kurtosis describes trends in a chart. A high kurtosis portrays a chart with a fat tail and a low even distribution, whereas a low kurtosis portrays a chart with skinny tails and a distribution concentrated toward the mean. Kurtosis may be referred to as the volatility of volatility. Risk-averse investors prefer a distribution with a low kurtosis (i.e., where returns are not far from the mean).

According to an exemplary embodiment, in gathering information, in particular, a skilled person may use one or more electronic computer data processing system to obtain, receive, collect, calculate or gather information on past returns data for purposes of filtering stocks or other securities, as well as on current returns for construction of a current volatility index value. The foregoing information on returns may include, but is not limited to, incremental daily returns for a stock calculated by taking a closing market price less the opening price, and dividing the difference by the opening price, represented as a percentage increase or decrease change.

According to an exemplary embodiment, a skilled person may use one or more electronic computer data processing systems to apply filters to, e.g., but not limited to, all available constituent stocks, with the aim of excluding certain stocks from index computation. The reason behind applying filters, according to an exemplary embodiment, may be to avoid undue influence of illiquid stocks or undue inclusion of irrelevant noise from outliers.

According to an exemplary embodiment, once a filtered universe of stocks has been constructed using the electronic computer data processing system, current returns of each stock may be computed, as well as the expected return across all stocks for the current time period. This may allow the skilled person to use an electronic computer data processing system to compute deviations from the expected return for each individual stock.

For the volatility index, in accordance with an exemplary embodiment, one or more electronic computer data processing systems may calculate deviations, which may be squared from the expected value and a weighting mechanism may be applied by the one or more electronic computer data processing systems to such squared deviations to generate by the one or more computers an aggregate measure of volatility. Such a volatility index, according to an exemplary embodiment, may provide information on average stock-specific volatility in the respective universe of stocks. The process, according to an exemplary embodiment, may also enable computing by the one or more electronic computer data processing systems indices of skewness and kurtosis in a manner as described further below. According to an exemplary embodiment, regular updating of the constituent universe, of the return information on individual stocks, and regular application of the exemplary filtering procedure may allow, by use of the one or more computing devices, maintaining and computing these indices frequently. For example, but not limited to, such indices could be maintained by providing, e.g., daily index values at market close.

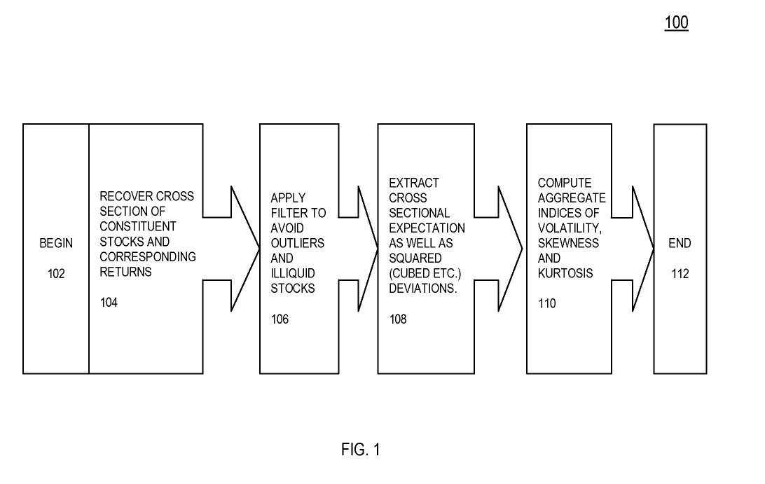

FIG. 1 depicts an exemplary embodiment of the index construction process according to an example embodiment of the present invention.

In an exemplary such embodiment, past returns data on a broad cross section of stocks may be obtained, collected and stored via at least on electronic computer data processing system database. A range of selection criteria may then be applied by the at least one computing device to this broad constituent data set to obtain a selection.

In an exemplary embodiment, one, two or more specific filters may be designed to remove stocks that would not add useful information to the securities indices. These filters may include, for example, filtering to remove outliers and/or illiquid stocks or securities. In an exemplary embodiment, outlier stocks may refer to stocks with highly extreme return movements within the reference period. In an exemplary embodiment, illiquid stocks may be identified by computing a measure of illiquidity, using one or more computing devices. Various such measures may be used.

Once a filtered cross sectional data set is defined, using the one or more computing devices, the expected return across all stocks over the reference time period may be defined, according to an exemplary embodiment. Based on this expectation, deviations from the expected return for each stock may be computed using the one or more processors of the computing devices, as well as, at least, for example, squared deviations, cubed deviations, and fourth order deviations, according to exemplary embodiments.

According to an exemplary embodiment, applying an exemplary weighting scheme to these stock-specific measures may allow computing via the one or more computer processor devices of standardized second, third and fourth central moments of the cross sectional return distribution, which may serve as an index of volatility, skewness and kurtosis.

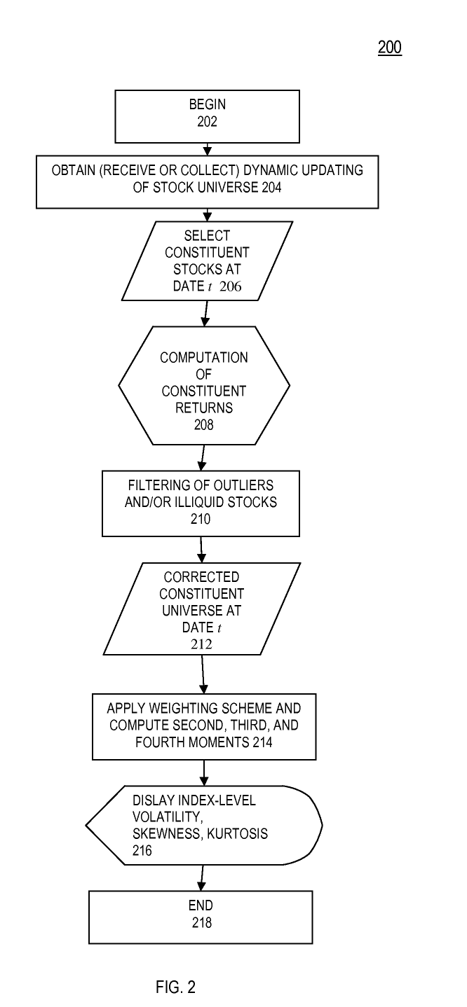

FIG. 2 depicts an exemplary embodiment of an overall process for the creation of an exemplary volatility index, skewness index and/or kurtosis index. Given the practical constraints on data availability, the index computation and maintenance process may be based on daily returns data, according to an exemplary embodiment. For example, for a given stock a daily return may be computed by electronic computer processing a calculation that takes a ratio of the quantity of the closing price, less the open price, all over the open price, expressed as a percentage increase or decrease return. All positive or negative daily returns for all stocks or securities may be aggregated together and various statistical analyses may be performed using at least one electronic computing device to provide indices indicative of the market's volatility, skewness and/or kurtosis. Accordingly, the index construction system may thus provide end-of-day measures of aggregate volatility, skewness and kurtosis for a range of desired broad market and/or sector constituent universes.

In an exemplary embodiment, the index computation and maintenance process may include using a set of index constituents, which may have to be dynamically updated in order to reflect the current constitution of the relevant universe. Here, constituent returns information may then be computed based on constituent prices by subtracting closing day price from opening price and dividing by opening price, to obtain a given stock's daily return.

In addition to current prices, the inventive system and corresponding processes, may electronically obtain and/or store data for time series of past returns of constituents. Based on an exemplary database of such data, a range of filters may be computationally applied, for example and not by way of limitation, that may allow for the eliminating of certain stocks from the universe used for index calculation, according to an exemplary embodiment.

In an exemplary embodiment, a first filter may computationally eliminate some, a substantial portion of, or all of the illiquid stocks, or other filtered elements or securities. In one such exemplary embodiment, illiquid stocks may be identified as stocks having stale prices, as indicated, for example, but not limited to, by having zero returns over a given day or by having a high 1st order autocorrelation. Similar, according to these embodiments, other liquidity measures may be used as well to eliminate constituent stocks with liquidity problems.

In an exemplary embodiment, a second filter may computationally remove some, a substantial portion of, or all stocks that are outliers in terms of the returns observations. To remove, minimize or eliminate outliers, the process may computationally use statistical methods such as, e.g., but not limited to, principal component analysis (such as computationally eliminating stocks with negative weight in the first principal component) to electronically eliminate outliers based on, for example (and not by way of limitation) historical data or the constituent filter may remove the stocks that are identified as outliers in terms of current daily returns. Such removal of outliers in terms of historical data or current data may achieve greater robustness of the derived risk measure, i.e. the volatility, skewness or kurtosis index. According to an exemplary embodiment, any of various well known, quantile-based estimation techniques may be used, with at least one computer to compute volatility, skewness and kurtosis, and may allow rendering the computed risk measures more robust than for conventional approaches.

In an exemplary embodiment, once the constituent universe for index computation has been defined and the filters have removed undesirable constituents, squared deviations (and cubed deviations and fourth order deviations) of remaining constituent returns from the cross sectional expected return may be computed using at least one electronic computing device with at least one computer processor. According to an exemplary embodiment, a weighting scheme may then be applied to these individual stock deviations in order to compute the aggregate measure of volatility, skewness and/or kurtosis.

For the case of the volatility index, a skilled person may compute volatility CVIXₜ using at least one electronic computing device, as:

$${CVIX}_{t} = \sqrt{{\sum }_{i = 1}^{N - F} {{w}_{i , t} [ {r}_{i , t} - E ( {r}_{i , t} ) ]}^{2}} . \qquad Equation 1$$

For the case of the cross-sectional skewness index (CSIXₜ in short), a skilled person may compute:

$${CSIX}_{t} = \frac{{\sum }_{i = 1}^{N - F} {{w}_{i , t} [ {r}_{i , t} - E ( {r}_{i , t} ) ]}^{3}}{{( {\sum }_{i = 1}^{N - F} {{w}_{i , t} [ {r}_{i , t} - E ( {r}_{i , t} ) ]}^{2} )}^{3 / 2}} . \qquad Equation 2$$

For the case of the cross-sectional kurtosis index (CKIXₜ in short), a skilled person compute:

$${CKIX}_{t} = \frac{{\sum }_{i = 1}^{N - F} {{w}_{i , t} [ {r}_{i , t} - E ( {r}_{i , t} ) ]}^{4}}{{( {\sum }_{i = 1}^{N - F} {{w}_{i , t} [ {r}_{i , t} - E ( {r}_{i , t} ) ]}^{2} )}^{2}} . \qquad Equation 3$$

In the above equations, N is the number of initial constituents, F is the number of constituents removed through the filters, E(.) denotes the expected value, r_{i,t} denotes the current period's (e.g. today's) return on stock i, and w_{i,t} denotes the current weighting for stock i. In an exemplary embodiment, the weighting scheme that may allow computing of the current weight of each stock (w_{i,t}) may be handled quite flexibly, allowing for the computing of smoothed versions of the index using robust regression techniques, for example. Robust regression, according to an exemplary embodiment, can be used in any situation in which one would use standard regression analysis, as will be apparent to those skilled in the art, and can be used for finding out that one or more data points are seemingly very different from the rest of the observations, and seem to qualify as outliers. Broadly speaking, robust regression, according to an exemplary embodiment, is a compromise between deleting these outlier points, and allowing the outliers to violate the assumptions of standard regression analysis. More precisely, this approach according to an exemplary embodiment of the invention may include regressing cross-sectional returns (e.g., after filters have been applied to remove obvious outliers) against a vector of ones using an exemplary robust regression. The weights obtained may indicate which observations the robust method identifies as outliers, to which a small weight may be applied, in an exemplary embodiment. For more details on exemplary robust regression techniques, which may be used in exemplary embodiments of the present invention, and how these example techniques can be applied to data, and in this case financial data, the reader is referred to U.S. Pat. No. 6,523,015 B1, issued Feb. 18, 2003, the contents of which are incorporated herein by reference in their entirety.

To obtain a volatility index that is broadly representative of its market segment, a skilled person in accordance with the embodiments may compute weights by market capitalization. Alternatively, such skilled person may weight stocks, by for example, daily trading volume to reflect the informativeness of a given stock's price change, as a low volume price change may be simply due to illiquidity. In yet another embodiment, an equal weight may be provided to each stock.

In an exemplary embodiment, the resulting volatility index may have the advantage of being entirely model-free, while conventional approaches may rely on strong assumptions, such as, e.g., but not limited to, concerning the pricing relation between options and underlying assets, and/or concerning the process governing the time series of asset returns.

In addition, the approach of such exemplary embodiments may use the full set of information available in the cross section of returns of a broad constituent universe. On the other hand, existing approaches to computing volatility indices and measures may rely on the information in option prices or past returns concerning a single asset, which usually is a market index.

Exemplary embodiments of the present index construction approach may also allow constructing the index on any set of constituents, which makes it possible to provide a wide range of volatility indices for selected stock universes (or universes of other securities having sufficient dispersion of performance), rather than just providing a volatility index for the widely used market indices.

Within the process, according to an exemplary embodiment, one may compute standardized central moments of higher order in addition to the second order computation which yields the volatility index using at least one electronic computing device as described further below in an exemplary embodiment. Such skewness and kurtosis indices are of interest to investors who may wish to measure the current level of risk in a given segment of the stock market taking into account information beyond volatility alone.

In another example embodiment, a similar methodology may be applied to securities other than stock or equities. In an exemplary embodiment of the invention, the method may be applied to securities within a universe where a sufficient amount of cross-sectional dispersion exists. An non-limiting example of an exemplary embodiment of securities having sufficient cross-sectional dispersion may include bonds, for example. In another exemplary embodiment, securities such as, e.g., but not limited to, mutual funds, active mutual funds, or hedge funds, may also be used. According to one exemplary embodiment, the present invention may not be generally effective with such securities as passive mutual funds, or ETFs, if not displaying enough dispersion in their performance. According to an exemplary embodiment, exemplary embodiments of the present invention are of highest relevance in the equity universe. According to another exemplary embodiment, a universe of other securities may be used.

Exemplary Processing and Communications Embodiments

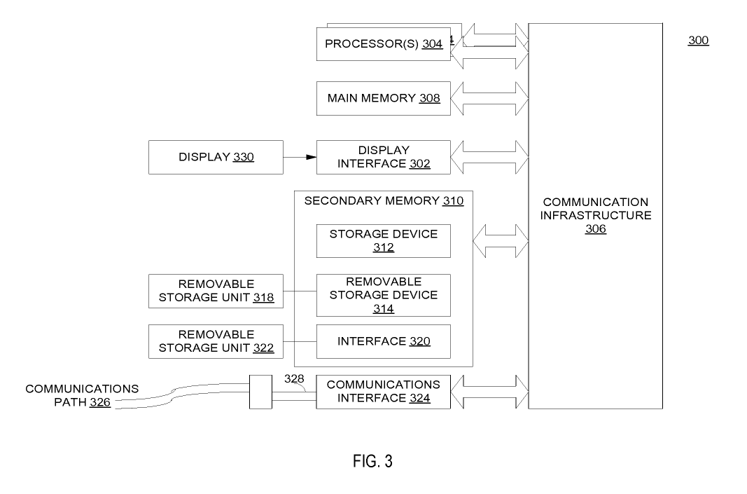

FIG. 3 depicts an exemplary embodiment of a computer system 300 that may be used in association with, in connection with, and/or in place of, but not limited to, any of the foregoing components and/or systems, according to an exemplary embodiment. Various exemplary electronic computer systems may be networked to one another and integrated to collectively compute and perform elements of the exemplary embodiments. Such computing systems may include, e.g., but are not limited to, an index design computing device, an index creation and construction computing device, an index calculation device, an index management device, a portfolio creation device, a portfolio management device, a securities trading device, an index storage and access database, an index display and communication device, among others, etc., according to various exemplary embodiments. It should be noted, however, that the exemplary embodiments of the invention may be implemented on any computing device(s), processor(s), computer(s) and/or communications device(s).

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 300 is shown in FIG. 3, depicting an exemplary embodiment of a block diagram of an exemplary computer system useful for implementing the present invention. Specifically, FIG. 3 illustrates an example computer 300, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® 7/XP/NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., ANDROID from Google Corporation, or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system, communications, or other device, running any appropriate operating system. In one exemplary embodiment, the present invention may be implemented on a computer system operating as discussed herein. An exemplary computer system, computer 300 is shown in FIG. 3. Other components of the invention, such as, e.g., (but not limited to) a computing device, a communications device, a telephone, a personal digital assistant (PDA), a personal computer (PC), a handheld PC, an iPhone, an iPAD, a mobile phone, a tablet, a cell phone, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 3.

The computer system 300 may include one or more processors, such as, e.g., but not limited to, processor(s) 304. The processor(s) 304 may be connected to a communication infrastructure 306 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 300 may include a display interface 302 that may forward, e.g., but not limited to, graphics, text, and other data, etc., from the communication infrastructure 306 (or from a frame buffer, etc., not shown) for display on the display unit 330.

The computer system 300 may also include, e.g., but may not be limited to, a main memory 308, random access memory (RAM), and a secondary memory 310, etc. The secondary memory 310 may include, for example, (but not limited to) a hard disk drive 312 and/or a removable storage drive 314, representing a floppy diskette drive, a magnetic tape drive, an optical disk drive, a compact disk drive CD-ROM, an SD ram card, a flash device, a USB storage device, etc. The removable storage drive 314 may, e.g., but not limited to, read from and/or write to a removable storage unit 318 in a well known manner. Removable storage unit 318, also called a program storage device or a computer program product, may represent, e.g., but not limited to, a floppy disk, magnetic tape, optical disk, compact disk, etc. which may be read from and written to by removable storage drive 314. As will be appreciated, the removable storage unit 318 may include a computer usable storage medium having stored therein computer software and/or data.

In alternative exemplary embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 322 and interfaces 320, which may allow software and data to be transferred from the removable storage unit 322 to computer system 300.

Computer 300 may also include an input device such as, e.g., (but not limited to) a mouse or other pointing device such as a digitizer, and a keyboard or other data entry device (none of which are labeled).

Computer 300 may also include output devices, such as, e.g., (but not limited to) display 330, and display interface 302. Computer 300 may include input/output (I/O) devices such as, e.g., (but not limited to) communications interface 324, cable 328 and communications path 326, etc. These devices may include, e.g., but not limited to, a network interface card, and modems (neither are labeled). Communications interface 324 may allow software and data to be transferred between computer system 300 and external devices. Examples of communications interface 324 may include, e.g., but may not be limited to, a modem, a network interface (such as, e.g., an Ethernet card), a communications port, a Personal Computer Memory Card International Association (PCMCIA) slot and card, etc. Software and data transferred via communications interface 324 may be in the form of signals 328 which may be electronic, electromagnetic, optical or other signals capable of being received by communications interface 324. These signals 328 may be provided to communications interface 324 via, e.g., but not limited to, a communications path 326 (e.g., but not limited to, a channel). This channel 326 may carry signals 328, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 314, a hard disk installed in hard disk drive 312, and signals 328, etc. These computer program products may provide software to computer system 300. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 308 and/or the secondary memory 310 and/or removable storage units 314, also called computer program products. Such computer programs, when executed, may enable the computer system 300 to perform the features of the present invention as discussed herein. In particular, the computer programs, when executed, may enable the processor 304 to provide a method to resolve conflicts during data synchronization according to an exemplary embodiment of the present invention. Accordingly, such computer programs may represent controllers of the computer system 300.

In another exemplary embodiment, the invention may be directed to a computer program product comprising a computer readable medium having control logic (computer software) stored therein. The control logic, when executed by the processor 304, may cause the processor 304 to perform the functions of the invention as described herein. In another exemplary embodiment where the invention may be implemented using software, the software may be stored in a computer program product and loaded into computer system 300 using, e.g., but not limited to, removable storage drive 314, hard drive 312 or communications interface 324, etc. The control logic (software), when executed by the processor 304, may cause the processor 304 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc. Bluetooth is an emerging wireless technology promising to unify several wireless technologies for use in low power radio frequency (RF) networks. IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc.

### CONCLUSION

In this document, the terms “computer program medium” and “computer readable medium” may be used to generally refer to media such as, e.g., but not limited to removable storage drive, a hard disk installed in hard disk drive, and signals, etc. These computer program products may provide software to computer system. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as, e.g., but not limited to, “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

What is claimed is:

1. A method of constructing data indicative of a volatility index using at least one computing device comprising at least one processor and at least one memory, the method comprising:
obtaining, by the at least one processor, data indicative of a universe of securities;
selecting, by the at least one processor, data indicative of constituent securities at a given date;
computing, by the at least one processor, data indicative of constituent returns for said constituent securities;
filtering, by the at least one processor, data indicative of outliers;
applying, by the at least one processor, weighting comprising data based on
computing, by the at least one processor, at least one of:
a second moment,
a third moment, or
a fourth moment,
to obtain the index.

2. The method according to claim 1, wherein said index comprises a cross-sectional volatility index (CVIXₜ) comprising:
$${CVIX}_{t} = \sqrt{{\sum }_{i = 1}^{N - F} {{w}_{i , t} [ {r}_{i , t} - E ( {r}_{i , t} ) ]}^{2}} .$$

3. The method according to claim 1, wherein said index comprises a cross-sectional skewness index (CSIXₜ) comprising:
$${CSIX}_{t} = \frac{{\sum }_{i = 1}^{N - F} {{w}_{i , t} [ {r}_{i , t} - E ( {r}_{i , t} ) ]}^{3}}{{( {\sum }_{i = 1}^{N - F} {{w}_{i , t} [ {r}_{i , t} - E ( {r}_{i , t} ) ]}^{2} )}^{3 / 2}} .$$

4. The method according to claim 1, wherein said index comprises a cross-sectional kurtosis index (CKIXₜ), comprising:
$${CKIX}_{t} = \frac{{\sum }_{i = 1}^{N - F} {{w}_{i , t} [ {r}_{i , t} - E ( {r}_{i , t} ) ]}^{4}}{{( {\sum }_{i = 1}^{N - F} {{w}_{i , t} [ {r}_{i , t} - E ( {r}_{i , t} ) ]}^{2} )}^{2}} .$$

5. The method according to claim 1, wherein said universe of securities comprises securities having data indicative of more than a predetermined cross-sectional dispersion in the performance of the security, to allow for computing said moments.

6. The method according to claim 1, wherein said universe of securities comprises at least one of:
a universe of stocks; or
a universe of equities.

7. The method according to claim 1, wherein said universe of securities comprises bonds.

8. The method according to claim 1, wherein said universe of securities comprises at least one of:
a universe of mutual funds having cross-sectional dispersion; or
a universe of active mutual funds.

9. The method according to claim 1, wherein said universe of securities comprises a universe of hedge funds.

10. The method according to claim 1, wherein said weighting comprises:
weighting, by the at least one processor, said constituent securities by at least one of:
a market capitalization;
a daily trading volume; or
a security's price change.

11. The method according to claim 1, wherein said filtering comprises:
filtering, by the at least one processor, said constituent securities by a robust regression technique.

12. A system of constructing data indicative of a volatility index, comprising:
at least one computing device comprising:
at least one processor, and
at least one memory,
wherein said at least one processor is adapted to:
obtain data indicative of a universe of securities;
select data indicative of constituent securities at a given date;
compute data indicative of constituent returns for said constituent securities;
filter data indicative of outliers;
apply weighting comprising data based on
computing at least one of:
a second moment,
a third moment, or
a fourth moment,
to obtain the index.

13. A nontransitory computer program product embodied on a computer readable medium, the computer program product containing program logic, which when executed on at least one processor, enables said at least one processor to perform a method comprising:
obtaining, by the at least one processor, data indicative of a universe of securities;
selecting, by the at least one processor, data indicative of constituent securities at a given date;
computing, by the at least one processor, data indicative of constituent returns for said constituent securities;
filtering, by the at least one processor, data indicative of outliers;
applying, by the at least one processor, weighting comprising data based on
computing, by the at least one processor, at least one of:
a second moment,
a third moment, or
a fourth moment,
to obtain the index.

14. The nontransitory computer program product according to claim 13, wherein said index comprises a cross-sectional volatility index (CVIXₜ) comprising:
$${CVIX}_{t} = \sqrt{{\sum }_{i = 1}^{N - F} {{w}_{i , t} [ {r}_{i , t} - E ( {r}_{i , t} ) ]}^{2}} .$$

15. The nontransitory computer program product according to claim 13, wherein said index comprises a cross-sectional skewness index (CSIXₜ) comprising:
$${CSIX}_{t} = \frac{{\sum }_{i = 1}^{N - F} {{w}_{i , t} [ {r}_{i , t} - E ( {r}_{i , t} ) ]}^{3}}{{( {\sum }_{i = 1}^{N - F} {{w}_{i , t} [ {r}_{i , t} - E ( {r}_{i , t} ) ]}^{2} )}^{3 / 2}} .$$

16. The nontransitory computer program product according to claim 13, wherein said index comprises a cross-sectional kurtosis index (CKIXₜ), comprising:
$${CKIX}_{t} = \frac{{\sum }_{i = 1}^{N - F} {{w}_{i , t} [ {r}_{i , t} - E ( {r}_{i , t} ) ]}^{4}}{{( {\sum }_{i = 1}^{N - F} {{w}_{i , t} [ {r}_{i , t} - E ( {r}_{i , t} ) ]}^{2} )}^{2}} .$$

17. The nontransitory computer program product according to claim 13, wherein said universe of securities comprises securities having data indicative of more than a predetermined cross-sectional dispersion in the performance of the security, to allow for computing said moments.

18. The nontransitory computer program product according to claim 13, wherein said universe of securities comprises at least one of:
a universe of stocks; or
a universe of equities.

19. The nontransitory computer program product according to claim 13, wherein said universe of securities comprises bonds.

20. The nontransitory computer program product according to claim 13, wherein said universe of securities comprises at least one of:
a universe of mutual funds having cross-sectional dispersion; or
a universe of active mutual funds.

21. The nontransitory computer program product according to claim 13, wherein said universe of securities comprises
a universe of hedge funds.

22. The nontransitory computer program product according to claim 13, wherein said weighting comprises:
weighting, by the at least one processor, said constituent securities by at least one of:
a market capitalization;
a daily trading volume; or
a security's price change.

23. The nontransitory computer program product according to claim 13, wherein said filtering comprises:
filtering, by the at least one processor, said constituent securities by a robust regression technique.
